(19) United States
(12) Patent Application Publication
(10) Pub. No.: US 2013/0214931 A1
(43) Pub. Date: Aug. 22, 2013

(54) INDUCTION CHARGING SYSTEM

(71) Applicant: Vodafone IP Licensing Limited, (US)

(72) Inventor: Stanley CHIA, Newbury (GB)

(73) Assignee: Vodafone IP Licensing Limited, Newbury (GB)

(21) Appl. No.: 13/768,720

(22) Filed: Feb. 15, 2013

(30) Foreign Application Priority Data
Feb. 17, 2012 (GB) 1202764.5

(51) Int. Cl. H02J 7/00

(52) U.S. Cl. CPC H02J 7/0042
USPC 340/815.4; 320/108

(57) ABSTRACT

An apparatus for charging a mobile device includes an inductive coupler adapted to couple to an inductive charger such that, in use, the inductive coupler receives inductive charge from the inductive charger. The apparatus further comprises a battery and a battery charger, the battery charger being configured to transfer power from the inductive coupler to the battery. The apparatus further includes a power outlet adapted to provide power from the battery. In use, power received by the inductive coupler is transferred via the battery charger to charge the battery. When required, power may then be transferred from the battery to the power output. The power output can be connected to a power input of a mobile device and by this the internal battery of the mobile device may be charged using power stored in the battery of the charging apparatus.

### TECHNICAL FIELD

This application relates to a system and apparatus for facilitating charging of a device. In particular this application relates to the use of an induction charging system to allow the charging of a mobile device, including monitoring the charging process.

### BACKGROUND TO THE INVENTION

With the ever increasing popularity of electronic mobile devices which are designed to be portable enough to be carried by a user, it follows that there is an increasing need to provide power to such devices. This need is further enhanced by the increasing power requirements of such devices, and the relatively slow progress in the development of cheap, longer lasting batteries, for example devices such as Smartphones, consume more power and must be recharged more frequently than the mobile phones that they are replacing.

Typically users rely on locating a mains power source to charge their electronic devices, and the user must carry a charger which is compatible with each device they own in order to charge each device.

A problem arises if the user is unable to locate an available mains power point, no compatible charging adapter is available, or they are not able to wait in a particular location for the period of time required to sufficiently recharge a device.

Accordingly, it would be desirable to provide a system to enable the recharging of a mobile device even if the device is not stationary. Furthermore, it would be desirable to provide a system for securely storing a mobile device during the recharging of the battery of the device, and a system for monitoring the status of the device being charged.

### SUMMARY OF THE INVENTION

According to the system described herein, an apparatus for charging a mobile device includes an inductive coupler adapted to couple to an inductive charger such that, in use, the inductive coupler receives inductive charge from the inductive charger. The apparatus further comprises a battery and a battery charger, the battery charger being configured to transfer power from the inductive coupler to the battery. The apparatus further includes a power outlet adapted to provide power from the battery.

In use, power received by the inductive coupler is transferred via the battery charger to charge the battery. When required, power may then be transferred from the battery to the power output. The power output can be connected to a power input of a mobile device and by this the internal battery of the mobile device may be charged using power stored in the battery of the charging apparatus.

The inductive coupler, in conjunction with the inductive charger, provides a system for wireless charging of the battery via the battery charger. The inductive coupler and inductive charger may be physically separated whilst power transfer occurs, without any additional wired connection. The inductive coupler and inductive charger may be separated to the extent that efficient electromagnetic induction can still occur, for example by the thickness of a narrow barrier or a piece of cloth. The inductive coupler may comprise a conducting inductance coil. When in close proximity to an inductive charger having a second inductance coil conducting a finite current, a voltage is induced in the inductive coupler.

The power outlet may be any connection or wire through which power stored in the battery may be output. The power outlet may be configured to connect directly to a mobile device, or may comprise a plug or socket to which a wire or connector can be attached.

The apparatus may further comprise the inductive charger which is configured to connect to a power source. For example, the inductive charger may be intermediate the inductive coupler and the power source, and may provide a connection therebetween. The power source may comprise, for instance, a mains electricity connection or an electricity generator. The inductive charger is necessary for supplying power to the inductive coupler for eventual storage in the battery. The inductive charger does not need to be coupled to the inductive coupler to enable power to be output from the power outlet. Optionally, the apparatus may further comprise a voltage regulator or transformer arranged to adapt the voltage input from the power source in relation to the voltage output at the power outlet.

The apparatus may be substantially portable. The apparatus may further comprise a bag which contains the inductive coupler, battery and battery charger. The power outlet may also be enclosed within the bag, or may extend outside the bag. The components may be embedded into the structure of the bag: for example, the battery may by be contained within the lining of the base of the bag, or the inductive coupler may be comprised within a wall of the bag. The bag may be any type of carrying apparatus, for example a handbag, holdall, briefcase, rucksack or satchel. Beneficially, inclusion of a bag allows the apparatus to be easily transportable, and may also allow use of the charging apparatus to charge a mobile device when in transit.

Optionally, the bag may comprise a securing mechanism to retain a mobile device. The securing mechanism may be a pocket or strap, and may be adaptable to accommodate a range of mobile devices. The securing mechanism may be arranged within the bag so as to securely hold and protect the mobile device in a position suitable for connection to the power outlet of the charging apparatus.

Optionally, the inductive coupler is arranged to receive inductive charge from the inductive charger though an outer surface of the bag. For example, the inductive coupler is arranged within the bag such that the inductive charger, which remains outside the bag, can be aligned with the inductive coupler and the outer surface of the bag is positioned therebetween. Advantageously, this allows the inductive coupler to be incorporated within the bag so as to be easily portable, without requiring unsightly plugs or sockets on the outside of the bag.

The apparatus may include an alignment mechanism to align the inductive coupler with the inductive charger, and in particular to enable correct alignment of the inductive coupler and inductive charger for efficient power transfer. The alignment mechanism may be one or more of a group consisting of a visible marking, use of different material in the bag outer at the location of the inductive coupler, or pairs of cooperating magnets.

The apparatus may further comprises a charging connector for connection of the power outlet to the mobile device. Power is transferred from the power outlet through the charging connector to a connector of the mobile device. The charging connector may comprise a plug or socket, for example a male or female USB, mini USB, micro USB connector or manufacturer-specific connector. The charging connector may be configured to attach directly to the mobile device, or to connect to an adapter or cable for connection between the power outlet and the mobile device.

The charging connector may be reconfigurable for connection to different types of mobile device having different types of power input connector. For example, the charging connector may comprise a socket and a detachable adapter. The adapter may be interchangeable with a plurality of adapters, each adapter providing a different connector. Therefore, the user may exchange the charging connector so as to be compatible with many types of plugs or sockets on different mobile devices. The charging connector may further comprise a length of wire to extend the reach of the power output with respect to the rest of the charging apparatus.

The apparatus may include a recharging cable connecting the power outlet and charging connector. Beneficially, the cable allows an increased distance between the power outlet and charging connector, giving greater convenience to the user. Optionally, a reel, roller or bobbin is provided, arranged to retract the recharging cable for storage. For example, the reel may be attached within the bag and be arranged to retract the recharging cable when the charging connector is not being handled by the user. The reel provides added convenience to the user by allowing a long length of recharging cable to be neatly stowed.

The apparatus may comprise a status indicator for indicating the status of the mobile device or status of the apparatus for charging the mobile device. The status indicator may be attached to the apparatus or bag (for example, being a charm or decoration), or may be physically separate from the apparatus or bag (for example, being a key ring). The status indicator may be provided so as to be visible to the user when the charging apparatus is in use or during the transportation of the apparatus.

Beneficially, the status indicator may comprise a receiver and a display. The receiver may be configured to receive status parameter information transmitted by the mobile device or charging apparatus. The receiver may be a wireless receiver for receiving information via Wi-Fi or Bluetooth, or may be attached to a wired connection to the mobile device or charging apparatus.

The display of the status indicator may, for example, be one or more LEDs, or may be an LCD display showing text, an icon or other indicator. In operation, the status indicator may provide notification to the user of the power level of the battery of the charging apparatus, the power level of the internal battery of the mobile device or the whether the battery or internal battery of the mobile device is currently charging. The status indicator may further indicate whether a call, SMS or text-based message has been received by the mobile device, or any other information regarding the status of the mobile device.

According further to the system described herein, an apparatus for receiving status parameter updates comprises a receiver for receiving the status parameter update from a transmitter, wherein the transmitter is coupled to a device having a status parameter. The apparatus for receiving status parameter updates also comprises a display which, when in operation, is adapted to display an indication of the status parameters. The apparatus for receiving status parameter updates is also referred to here as a status indicator, and advantageously may be configured for use in conjunction with the previously described apparatus for charging a mobile device. Advantageously, the apparatus for receiving status parameter updates allows a user to receive notification of current status information from a mobile device when the device is not readily accessible, or when the mobile device is not visible.

The apparatus for receiving status parameter updates may be substantially portable. For example, the apparatus for receiving status parameter updates may be incorporated into a key ring or into a charm for attachment to a bag. Alternatively, the apparatus for receiving status parameter updates may be incorporated into an object which is not intended to be often transported, for example a desk accessory.

The apparatus for receiving status parameter updates may further comprise a battery for providing power to the apparatus. Thus, the apparatus may be easily transportable, and does not need a wired connection to a power source.

The status parameter may be any type of status information available to the mobile device. The status parameter may be selected from the group consisting of any one or more of: the charge level of the internal battery of the mobile device, the charging status of a mobile device (for example, whether the mobile device is currently charging, or whether charging is complete), the receipt of a communication by a mobile device (for example, receipt of a SMS or text-based message, or a missed telephone call) or the level of network connectivity of the mobile device. The status parameters may further include an indication of the status of any devices attached to the mobile device, for example the charge level of the battery of the previously described apparatus for charging a mobile device.

The apparatus for receiving status parameter updates may communicate with the mobile device through any suitable mechanism. For example, the communication mechanism may be selected from the group consisting of any one or more of a wired connection, a wireless connection and a Bluetooth connection. Advantageously, use of a wireless or Bluetooth connection allows the apparatus for receiving status parameter updates to receive status parameter updates even when the apparatus is some distance from the mobile device.

According further to the system described herein, an application for execution on a mobile device comprising logic configured to transmit a status parameter of the mobile device to an external status indicator. The application may be used in conjunction with the previously described status indicator (or apparatus for receiving status parameter updates) to transmit information that can be received and displayed by the status indicator.

The application may be configured to transmit the status parameter via a connection selected from the group consisting of any one or more of a wired connection, a wireless connection, and a Bluetooth connection. The type of connection may be selected by the user in order to be received by a particular device. For example, the user may select the type of connection to be compatible with the previously described apparatus for receiving status parameter updates.

The status parameter transmitted by the application may be any type of status information available to the mobile device. The status parameter may be selected from the group consisting of any one or more of: the charge level of the internal battery of the mobile device, the charging status of a mobile device, the receipt of a communication by a mobile device or the level of network connectivity of the mobile device.

The combination of any of the features described herein is also provided even if not explicitly disclosed. Furthermore, it will be understood that method features corresponding with the structural, apparatus features described herein may optionally be provided in conjunction with the above-described apparatus.

### BRIEF DESCRIPTION OF THE DRAWINGS

Embodiments of a system and apparatus according to the system described herein will now be described, by way of example only, with reference to the accompanying drawings in which:

FIG. 1 illustrates a schematic representation of a bag according to an embodiment of the system described herein;

FIG. 2 illustrates a schematic representation of the inside of the bag shown in FIG. 1;

FIG. 3a illustrates a schematic representation of a second pocket according to an embodiment of the system described herein;

FIG. 3b illustrates a cross-section of the second pocket shown in FIG. 3a according to an embodiment of the system described herein;

FIG. 4 is a block diagram illustrating the components of a system for charging the mobile device;

FIG. 5 is a schematic representation showing the components of the system of FIG. 4 placed inside the bag;

FIG. 6a is a schematic illustration of a bag and an inductive charger according to an embodiment of the system described herein;

FIG. 6b is a schematic illustration of the bag and inductive charger of FIG. 6a in inductive charging configuration;

FIGS. 7a-7d show a schematic illustration of a status indicator according to an embodiment of the system described herein, where the status indicator is showing various charge statuses;

FIG. 8a shows a schematic illustration of the status indicator of FIGS. 7a-7d attached to the bag; and

FIG. 8b shows a schematic illustration of a switch for activation of the status indicator according to an embodiment of the system described herein.

### DETAILED DESCRIPTION OF VARIOUS EMBODIMENTS

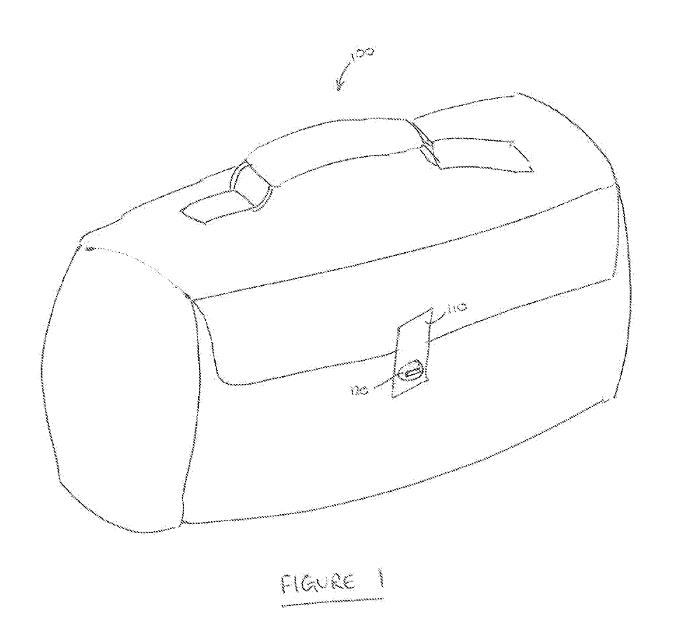

FIG. 1 illustrates a bag 100 according to an embodiment of the system described herein. In FIG. 1, the bag 100 is a satchel, however, the bag 100 may be any kind of bag, such as a rucksack, messenger bag, briefcase, holdall, handbag or some other kind of bag.

A mobile device is placed inside the bag and the bag 100 is secured by a buckle 110, alternatively, the bag 100 may be secured by a zip, buckle, material flap, poppers, buttons or any other device for covering the opening of the bag to reduce the likelihood of opportunistic theft of the mobile device. The buckle 110 may also comprise a lock 120 which may be any kind of lock, such as, an integral lock, a padlock or a combination lock.

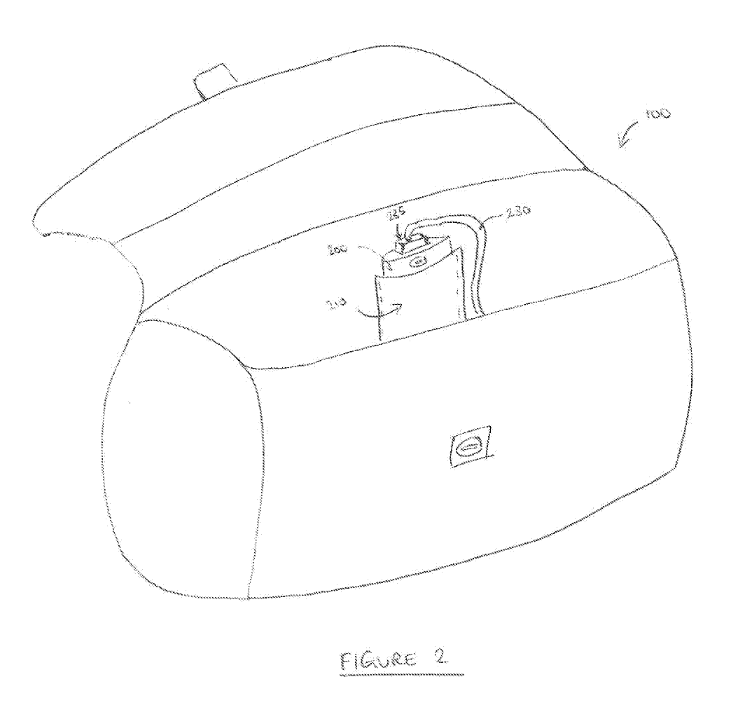

FIG. 2 shows a schematic illustration of the inside of the bag 100. A mobile device 200 comprising an internal battery is placed within a pocket 210 which securely holds the mobile device 200. The mobile device 200 is any device such as a mobile telephone, a smart phone, a PDA, a tablet computer, a GPS or a satellite navigation system. In the following described embodiments, where reference is made to charging/recharging the mobile device, it is meant that it is charging/recharging the internal battery of the mobile device.

The pocket 210 may be formed by attaching a piece of material to the inside surface of the bag 100. The pocket 210 may be attached by sewing, gluing or welding the pocket 210 to the inside surface of the bag 100. The pocket 210 may be made of the same material that the bag 100 is made of. Alternatively, the pocket 210 may be made of another material, for example, the pocket 210 may be made of a transparent material (such as a transparent polymer) which allows the display of the mobile device to be seen from inside and/or outside of the bag, or the pocket 210 may be made of an elasticated material.

The bag 100 may have an internal lining which serves to improve the appearance of the inside of the bag 100, and the pocket 210 may be formed by attaching a piece of material to the internal lining of the bag 100. Alternatively, instead of attaching a pocket 210 to the outer (visible) surface of the internal lining, the pocket 210 may be formed by attaching a pocket 210 to the inner surface of the internal lining (that is, the surface that is not visible because it is between the lining and the inside of the bag 100). A slit may then be cut in the inner lining to allow access to the pocket 210.

The pocket 210 is sized to fit the mobile device 200. As mobile devices 200 are available in a variety of sizes, the pocket 210 may be sized to fit a particular mobile device 200, or the pocket 210 may be sized to fit the largest device envisaged for use with the bag 100. Alternatively, the pocket 210 may be adaptable to accommodate mobile devices 200 with a range of sizes, for example, using a zip, or a drawcord, or by being elasticated.

A recharging cable 230 is provided which comprises a connector 235. The connector 235 is a connector, such as a USB or micro USB connector, which is compatible with a recharging socket on the mobile device 200. The connector 235 is interchangeable so that the connector 235 may be changed to be compatible with any mobile device 200.

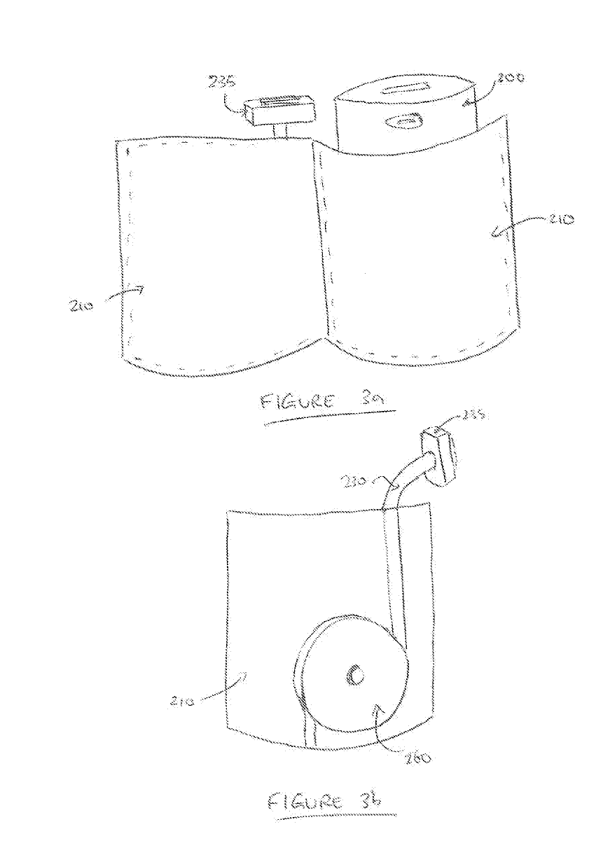

In certain embodiments, as shown in FIG. 3a, a second pocket 210 is provided to store the recharging cable 230. The second pocket 210 is attached on all sides with a gap just big enough to allow the recharging cable 230 to protrude through the top of the second pocket 210. When the recharging cable 230 is fully retracted into the second pocket 210, only the connector 235 protrudes from the top of the second pocket 210, and the size of the connector 235 prevents the connector 235 from being pushed into the second pocket 210.

FIG. 3b shows a cross-sectional view of the second pocket 210 according to certain embodiments where the recharging cable 230 has been wound on a retractable roller 260 which is placed inside the second pocket 210. In this way, the desired amount of charging cable 230 may be pulled out of the retractable roller 260 to enable the recharging cable 230 to be connected to the mobile device 200. However, when the recharging cable 230 is disconnected from the mobile device 200, the recharging cable 230 may automatically be wound back onto the retractable roller 260 so that the recharging cable 230 is neatly stored inside the pocket, thereby preventing the recharging cable 230 from getting tangled or damaged. As mentioned above, the second pocket 210 is stitched so that the connector 235 is larger than the hole in the top of the second pocket 210 so that the connector 235 is held captive in the top of the second pocket 210 ready for the next use.

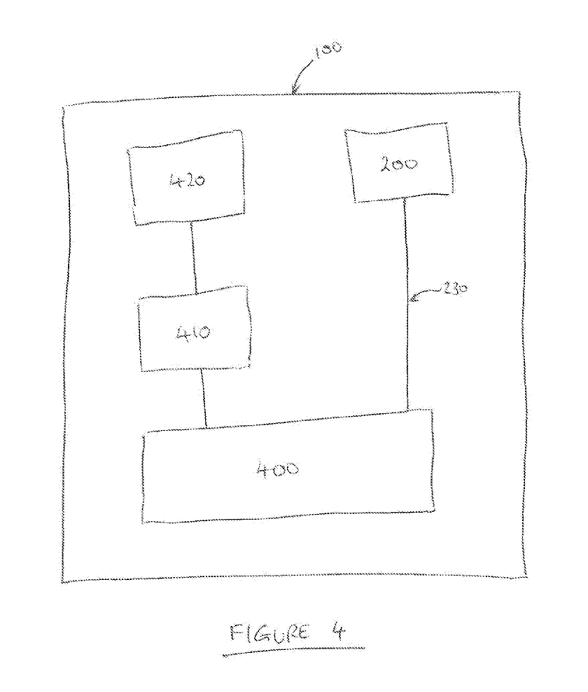

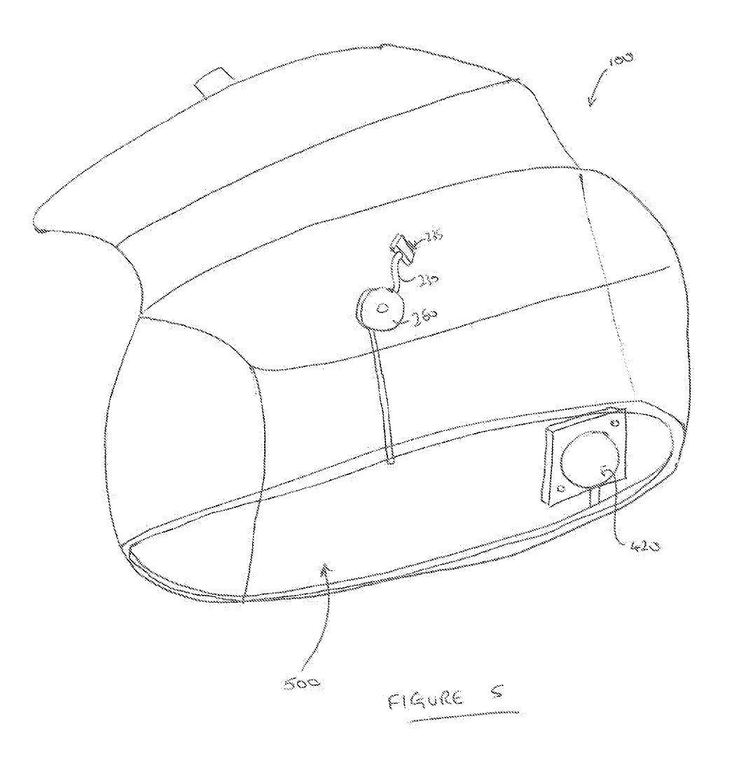

FIG. 4 is a block diagram illustrating the components of a system which are housed within the bag 100 for charging the mobile device 200 and FIG. 5 is a schematic illustration of the bag 100 showing the components of the system in FIG. 4 placed inside the bag.

The system comprises a battery 400 which stores energy so that the mobile device 200 may be charged while a user is away from a power source, for example, when the user is travelling. The battery may be any kind of rechargeable battery, such as, a lead-acid battery, a nickel cadmium (NiCd) battery, a nickel metal hydride (NiMH) battery, a lithium ion (Li-ion) battery, and a lithium ion polymer (Li-ion polymer) battery. The battery 400 is charged using a battery charger 410.

The battery 400 and battery charger 410 are built into a baseplate 500 which is hidden as a false bottom at the base of the bag 100, as shown in FIG. 5. Other electronics and cables necessary for the system may also be built into the baseplate 500. The baseplate 500 may be covered by the inner lining of the bag 100 or by another piece of material. Instead of being built into the bottom of the bag 100, the baseplate 500 could instead be built into a side, back, front or pocket of the bag 100.

The battery charger 410 is powered by an inductive coupler 420 which is configured to couple to an inductive charger. The inductive coupler 420 takes power from an electromagnetic field generated by the inductive charger and converts the electromagnetic field into electrical current which the battery charger 410 uses to charge the battery 400.

The battery 400 is attached to the mobile device 200 using the charging cable 230. The battery is configured to produce an output voltage and current profile which is suitable for charging the mobile device 200. In certain embodiments, an additional circuit including, for example, a transformer is provided which adapts the voltage to the needs of the mobile device 200.

The inductive coupler 420 is placed on the inside of the bag 100 and may be covered by the inner lining of the bag 100 or by another piece of material. In this example, the inductive coupler 420 is placed in the bottom right-hand corner of the front of the bag 100 (see FIG. 5). However, the inductive coupler 420 may be placed anywhere where the inductive coupler 420 may be easily located from outside the bag 100.

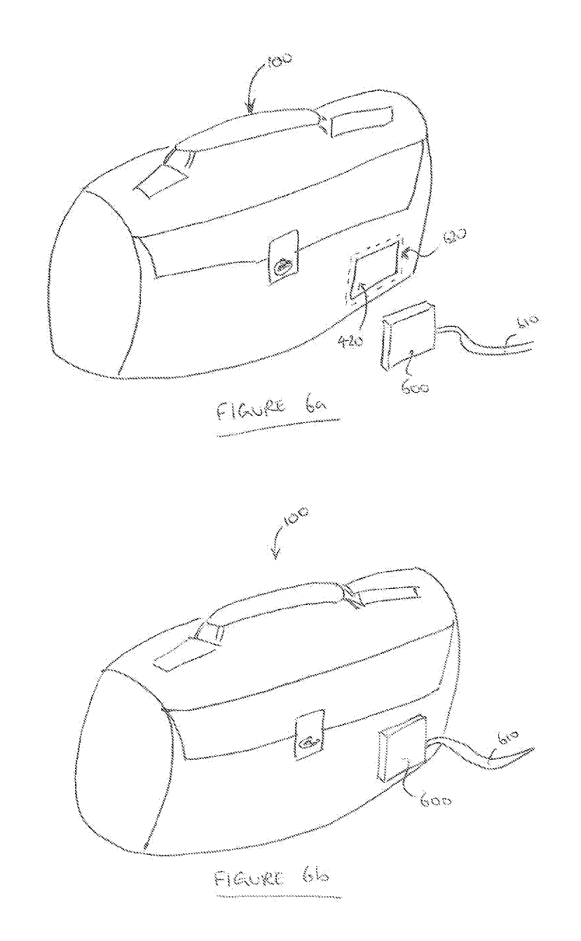

FIGS. 6a and 6b illustrates an inductive charger 600 for charging the battery 400 in the bag 100. The inductive charger 600 may be attached to a power source 610, such as a mains electricity supply, or a vehicle (for example, a car or van) or a solar panel.

As mentioned above, the inductive charger 600 is configured to couple with the inductive coupler 420 on the bag 100, as shown in FIG. 6b. In this example, the inductive charger 600 is configured to couple to the inductive coupler 420 using co-operating magnets which serve to locate and align the inductive coupler 420 with the inductive charger 600 as well as serving to hold the inductive coupler 420 and inductive charger 600 together while charging takes places. However, the inductive coupler 420 and the inductive charger 600 may be held together by any other device which serves to align and locate the inductive coupler 420 with the inductive charger 600 and which serves to hold the inductive coupler 420 and the inductive charger 600 together while charging takes place, for example, using clips, toggles, buttons, or a plug and socket arrangement.

To make it easier for the user to locate the position of the inductive coupler 420 from the outside of the bag 100, a visual marking 620 is provided on the outside of the bag 100 which indicates the location of the inductive coupler 420 to the user. In this example, the visual marking 620 comprises a square stitching pattern around the position of the inductive coupler 420. The visual marking 620 could take other forms, such as a depression pressed into the material of the bag 100, or a coloured patch, logo, symbol, text or graphic which may be printed, laser etched or otherwise marked on the bag 100. To reinforce the fact that the visual marking 620 indicates the location to place the inductive charger 600, the visual marking 620 may optionally be repeated on the inductive charger 600 The visual marking 620 may also indicate the correct orientation of the inductive charger 600 for attachment to the inductive coupler 420.

The inductive charger 600 may additionally comprise one or more indicators which indicate whether or not the inductive charger 600 is charging the battery 400 and/or whether the battery 400 is charged.

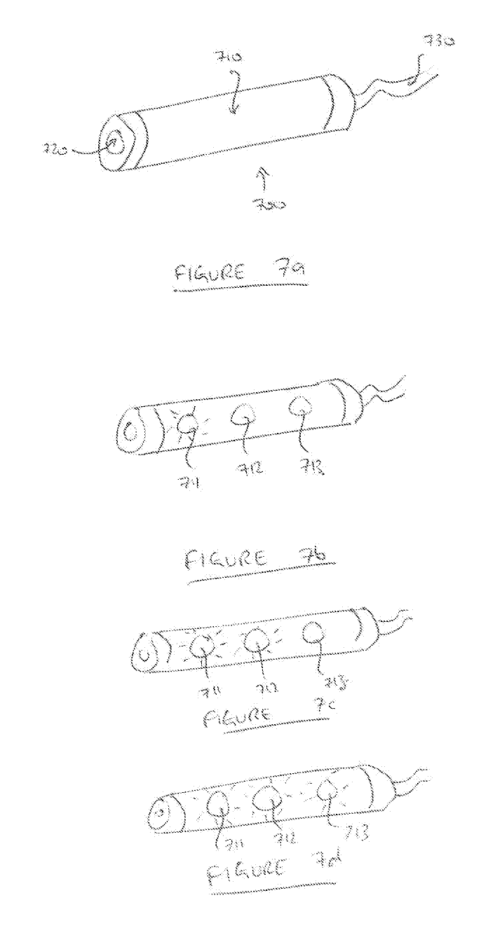

FIG. 7a illustrates a status indicator 700 for monitoring the status of the mobile device 200, and for indicating the level of battery charge or charging status of the mobile device 200 or the battery 400.

The status indicator 700 may also be used to indicate that the mobile device 200 has received a telephone call, a text message, a multimedia message, an email or some other communication. The status indicator 700 may also be used to indicate some other status of the mobile device 200, for example, indicating an alarm or calendar reminder.

The status indicator 700 comprises a status display 710. The status display 710 comprises one or more lights, such as one or more LEDs, which may be illuminated to show a status. Alternatively, or additionally, the status display 710 may comprise an LCD/LED panel which may be illuminated, or display an animation, graphics or text to indicate a status. Alternatively, or additionally, the status indicator 700 could include an alarm or loudspeaker or device for producing a vibration which may be used to indicate the status.

In the example shown in FIG. 7b-7d, the status display 710 comprises three LEDs 711-713. FIG. 7b illustrates the status indicator 710 showing that the battery is almost empty by illuminating only one LED 711. FIG. 7c illustrates the status indicator 710 showing that the battery is half-full by illuminating two LEDs 711 and 712. FIG. 7d illustrates the status indicator 710 showing that the battery is full or nearly full by illuminating all three LEDs 711-713.

The status display 710 may also comprise coloured LEDs, for example, a red LED 711, a yellow LED 712 and a green LED 713 to indicate that the battery is nearly empty, half-full and nearly full respectively.

Additionally or alternatively, one or more of the LEDs may flash to indicate a status, for example, the red LED 711 may flash to indicate that the battery is empty, or one or more of the LEDs may flash to indicate that the mobile device 200 has received a call.

In the example shown in FIGS. 7a-d, the status indicator 700 has a button 720 which may be pressed to instruct the status indicator 700 to show the status of the battery or mobile device 200. Alternatively, the status indicator 700 may be permanently illuminated, or the status indicator may be illuminated while switch 810 is activated which indicates that there is a mobile device 200 in the pocket 210.

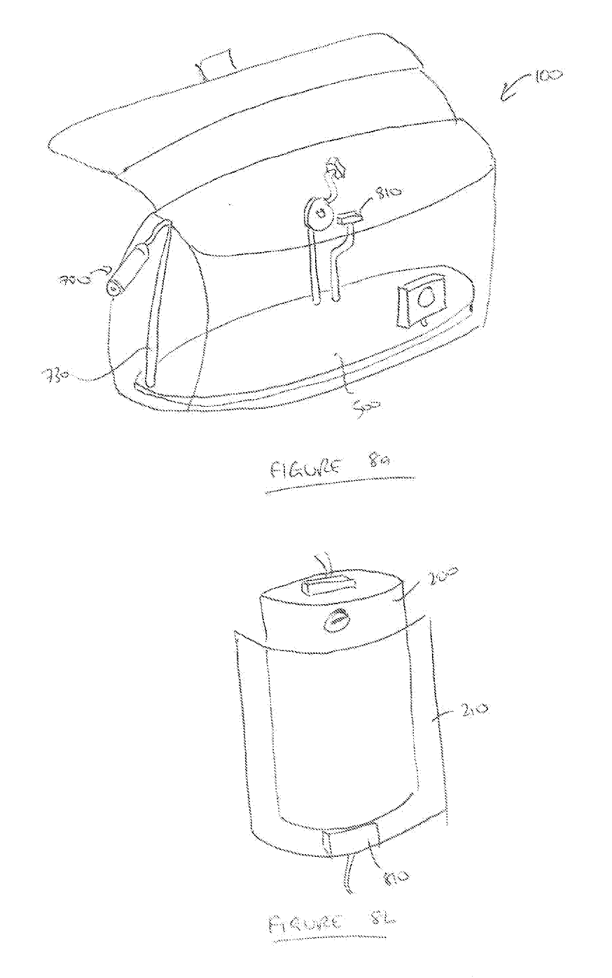

As shown in FIG. 8a, the status indicator 700 is connected to the baseplate 500 of the bag 100 using a cable 730. The status indicator 700 hangs from the outside of the bag 100 so that it is clearly visible to the user. Alternatively, the status indicator 700 may be incorporated into a zip or fastening of the bag.

Cable 730 provides power to the status indicator 700. Status information is provided by a connection (for example, a wireless connection such as a Bluetooth or Wi-Fi connection, or a wired connection, such as a USB connection) between the status indicator 700 and the mobile device 200. An application is provided on the mobile device 200 to provide this status information over the connection.

In this example, the status indicator 700 is connected to the mobile device 200 using a Bluetooth connection. The cable 730 is attached to a switch 810 which is placed inside the pocket 210, as shown in FIG. 8b. When the mobile device 200 is placed in the pocket 210, the weight of the mobile device 200 activates the switch 810 which initiates the Bluetooth connection to be made and causes the mobile device 200 to provide status information across the connection to the status indicator 700.

Of course, the status indicator 700 need not even be connected to the bag 100 and may be used independently, for example, the status indicator 700 may have a built-in battery and a built-in communications circuit which communicates with the bag 100 or the mobile device 200 using, for example, Bluetooth, Wi-Fi or some other communications protocol.

The status indicator 700 may alternatively or additionally indicate the charge status of the battery 400 located in bag 100

Although the system described herein is described in relation to a bag, the skilled person will appreciate that the system described herein could be practised in other portable forms and need not be limited to a bag, for example, an item of clothing or other personal adornment, or an animal harness or saddle.

Various embodiments discussed herein may be combined with each other in appropriate combinations in connection with the system described herein. Additionally, in some instances, the order of steps in the flowcharts, flow diagrams and/or described flow processing may be modified, where appropriate. Further, various aspects of the system described herein may be implemented using software, hardware, a combination of software and hardware and/or other computer-implemented modules or devices having the described features and performing the described functions. Software implementations of the system described herein may include executable code that is stored in a computer readable medium and executed by one or more processors. The computer readable medium may include volatile memory and/or non-volatile memory, and may include, for example, a computer hard drive, ROM, RAM, flash memory, portable computer storage media such as a CD-ROM, a DVD-ROM, a flash drive and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. An apparatus for charging a mobile device, comprising:
an inductive coupler adapted to couple to an inductive charger such that, in use, the inductive coupler receives inductive charge from the inductive charger;
a battery;
a battery charger for charging the battery, configured to transfer power to the battery from the inductive coupler; and
a power outlet adapted to provide power from the battery.

2. The apparatus according to claim 1, wherein the inductive charger configured to connect to a power source.

3. The apparatus according to claim 1, wherein the apparatus is substantially portable.

4. The apparatus according to claim 1, wherein the inductive coupler is arranged to receive inductive charge from the inductive charger through an outer surface of a bag.

5. The apparatus according to claim 1, further comprising:
an alignment mechanism to align the inductive coupler with the inductive charger.

6. The apparatus according to claim 5, wherein the alignment mechanism includes at least one of: a co-operating magnet or a visual marking.

7. The apparatus according to claim 1, further comprising:
a charging connector for connection between the power outlet and the mobile device.

8. The apparatus according to claim 7, wherein the charging connecter is reconfigurable for connection to different types of mobile device having different types of power input connector.

9. The apparatus according to claim 7, further comprising:
a recharging cable connecting the power outlet and charging connector; and
a reel arranged to retract the recharging cable for storage.

10. The apparatus according to claim 1, further comprising:
a status indicator for indicating a status of the mobile device or a status of the apparatus for charging the mobile device.

11. The apparatus according to claim 10, wherein the status indicator comprises a receiver and a display.

12. A bag, comprising:
an apparatus for charging a mobile device, the apparatus comprising:
an inductive coupler adapted to couple to an inductive charger such that, in use, the inductive coupler receives inductive charge from the inductive charger;
a battery;
a battery charger for charging the battery, configured to transfer power to the battery from the inductive coupler; and
a power outlet adapted to provide power from the battery.

13. The bag according to claim 12, wherein the inductive coupler is arranged to receive inductive charge from the inductive charger through an outer surface of the bag.

14. An apparatus for receiving status parameter updates, comprising:
a receiver for receiving the status parameter update from a transmitter, said transmitter coupled to a device having a status parameter; and
a display which, when in operation, displays an indication of the status parameter.

15. The apparatus according to claim 14, wherein the apparatus is substantially portable.

16. The apparatus according to claim 14, wherein the status parameter includes at least one of: (i) a charge level of the internal battery of a mobile device, (ii) a charging status of a mobile device, or (iii) receipt of a communication by a mobile device.

17. The apparatus according to claim 14, wherein the apparatus communicates with the mobile device through a connection that is at least one of: a wired connection, a wireless connection, or a Bluetooth connection.

18. The apparatus according to claim 14, further comprising:
a battery.

19. A non-transitory computer-readable medium storing software for execution on a mobile device, the software comprising:
executable code that transmits a status parameter of the mobile device to an external status indicator.

20. The non-transitory computer-readable medium according to claim 19, wherein the status parameter is transmitted via a connection that is at least one of: a wired connection, a wireless connection, or a Bluetooth connection.

21. The non-transitory computer-readable medium 19, further comprising:
executable code of an status indicator apparatus that receives and displays the transmitted status parameter.

22. The non-transitory computer readable medium according to claim 19, wherein the status parameter is at least one of: (i) a charge level of an internal battery of a mobile device, (ii) a charging status of a mobile device, or (iii) receipt of a communication by a mobile device.
